(19) United States
(12) Patent Application Publication
(10) Pub. No.: US 2011/0277583 A1
(43) Pub. Date: Nov. 17, 2011

(54) COMPACT FLY-BY-WIRE PEDAL ASSEMBLY

(75) Inventor: Ryan W. Elliott, Chatham (CA)

(73) Assignee: KSR Technologies Co., Ridgetown (CA)

(21) Appl. No.: 13/105,678

(22) Filed: May 11, 2011

Related U.S. Application Data
(60) Provisional application No. 61/333,960, filed on May 12, 2010.

(51) Int. Cl. G05G 1/44

(52) U.S. Cl. 74/512

(57) ABSTRACT

The electronic pedal assembly includes a housing configured to mount onto a fire wall of a vehicle. The housing includes a pair of spaced apart side walls extending outwardly from an elongated center portion, a first housing portion axially aligned with a second housing portion. A pedal arm is rotatably disposed in the first housing portion. The pedal arm includes an end portion. A rotatable member disposed in the second housing portion and is pivotably mounted to a second pivot rod. The rotatable member is mechanically linked to the end portion of the pedal arm so as to rotate about the second pivot rod upon depression of the pedal arm. A position sensor is connected to the rotatable member. The position sensor is operable to detect the degree of rotation of the rotatable member upon depression of the pedal arm.

### CROSS-REFERENCE TO RELATED APPLICATIONS

This Application claims the benefit of U.S. Provisional Application 61/333,960 filed on May 12, 2010, the disclosure of which is incorporated by reference herein in its entirety.

### FIELD OF THE INVENTION

The present invention is related to an electronic pedal assembly having a sensor for detecting the degree of rotation of an end portion of the pedal that is mechanically coupled to a rotatable member so as to rotate the rotatable member in response to depression of the pedal.

### BACKGROUND OF THE INVENTION

Pedal assemblies for use in fly-by-wire applications are well known. Typically the pedal assembly includes a bracket which supports a pedal arm on a pivot rod. An electronic or magnetic position sensor is mounted at the end of the pivot rod. When the pedal arm is depressed, the pivot rod is rotated by the pedal arm to pivot a rotor of the position sensor. An electronic signal indicative of the angular displacement of the pedal arm is generated by the position sensor. However, in many applications the package space for the bracket assembly is small, such as when a “fly-by-wire” pedal assembly is replacing a mechanical linkage. In such applications, the position sensor mounted at the end of the pivot rod falls outside of the package space. Accordingly, it would be desirable to produce a compact pedal assembly for use with in a fly-by-wire application.

### SUMMARY OF THE INVENTION AND ADVANTAGES

An electronic pedal assembly is provided. The electronic pedal assembly may be operable to either actuate braking of a vehicle by transmission of an electric signal to the brakes, or to control the engine throttle of the vehicle.

In instances where the pedal assembly is used to control acceleration of the vehicle, the pedal assembly is in electrical communication with the engine throttle. Depression of the pedal arm controls the acceleration and speed of the vehicle. Specifically, the degree to which the pedal arm is depressed corresponds to the degree to which the engine throttle is opened. For instance, a slight depression of the pedal arm results in a relatively minimal opening of the engine throttle; whereas complete depression of the pedal arm results in a wide open engine throttle.

In instances where the pedal assembly is used to control braking of the vehicle, the pedal assembly is in electrical communication with the brake system. Depression of the pedal arm controls the braking of the vehicle. Specifically, the degree to which the pedal arm is depressed corresponds to the degree to which the brake pads engage the wheel. For instance, a slight depression of the pedal arm results in a relatively slight compression of the brake pads with respect to the wheel; whereas complete depression of the pedal arm results in a maximum compression of the brake pads with respect to the wheel.

The electronic pedal assembly includes a housing configured to mount onto a fire wall of a vehicle. The housing includes a pair of spaced apart side walls extending outwardly from an elongated center portion. The housing includes a first housing portion and a second housing portion. The first housing portion is axially aligned with the second housing portion.

A pedal arm is rotatably disposed between the pair of side walls. The pedal arm includes an end portion opposite a free end. The free end of the pedal arm may include a pad providing surface space for the foot of a user. The end portion of the pedal arm is dispose in the first housing portion.

A rotatable member is pivotably mounted to a second pivot rod. The rotatable member and the second pivot rod are also housed between the pair of spaced apart side walls. Specifically, the rotatable member is disposed in the second housing portion. The rotatable member is mechanically linked to the end portion of the pedal arm so as to rotate about the second pivot rod upon depression of the pedal arm.

A position sensor is connected to the rotatable member. The position sensor is operable to detect the degree of rotation of the rotatable member upon depression of the pedal arm. The position sensor is further operable to transmit the degree of rotation to the vehicle so as to actuate the engine throttle in a manner corresponding to the degree of rotation of the rotatable member.

In a first preferred embodiment of the electronic pedal assembly, the end portion of the pedal arm includes a first gear segment. The first gear segment is rigidly formed to the end portion and rotatable about the first pivot point. The rotatable member includes a second gear segment configured to enmesh with the first gear segment. The rotatable member is rotatable about the second pivot point. The first gear segment is housed in the first housing portion. The second gear segment is housed in the second housing portion. The second gear segment is enmeshed with the first gear segment.

The position sensor is fixedly mounted to one of the pair of side walls, and the second gear segment is rotatably mounted to the position sensor. A processor is in electrical communication with the position sensor. The processor is operable to calculate the degree of pedal depression based upon the rotation of the rotatable member.

The first and second gear segments are configured to engage each other wherein rotation of the first gear segment about the first pivot point rotates the second gear segment about the second pivot point. For instance, the first gear segment and second gear segments may be a segmented portion of a helical gear, or a spur gear.

In a second preferred embodiment, the electronic pedal assembly utilizes a whole gear. Specifically, the end portion is fixedly attached to a first gear wheel. The first gear wheel is rotatably mounted to the first pivot point. A second gear wheel is pivotably attached to the second pivot point. The first gear may be a helical gear or a spur gear. The second gear is a corresponding helical or spur gear adapted to enmesh with the first gear.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an electronic pedal assembly of the present invention;

FIG. 2 is an exploded view of the electronic pedal assembly of FIG. 1;

FIG. 3 is a cross-sectional view of an electronic pedal assembly of FIG. 1;

FIG. 4 is a cross-sectional view of an electronic pedal assembly of FIG. 4, showing the pedal arm depressed;

FIG. 5 is a perspective view of the electronic pedal assembly having first and second helical gear; and

FIG. 6 is a perspective view of the electronic pedal assembly having first and second spur gear.

### DETAILED DESCRIPTION OF THE INVENTION

As shown in the Figures, an electronic pedal assembly 10 for use in a vehicle is provided. The pedal assembly 10 includes a pedal arm 12 and a housing 14. An end portion 16 of the pedal arm 12 is operable to rotate a rotatable member 18. A position sensor 20 is operable to detect the degree in which the rotatable member 18 is rotated. A processor 22 is operable to translate the degree of rotation into a degree of depression of the free end 24 of the pedal arm 12.

As shown in the Figures, the housing 14 is formed by a generally U-shaped bracket 26. The U-shaped bracket 26 includes an elongated center portion 28, and a pair of spaced apart side walls 30 extending from opposing side edges of the elongated center portion 28. The center portion may include apertures 32 for mounting the bracket 26 to the fire wall 34 of a vehicle (not shown). The housing 14 includes a first housing portion 36 and a second housing portion 38. The first housing portion 36 is axially aligned with the second housing portion 38. The first and second housing portions 36, 38 of the housing 14 may include apertures 32 and mounts for mounting the housing 14 onto a fire wall 34 of the vehicle.

The pedal arm 12 is disposed between the pair of side walls 30. The pedal arm 12 includes a free end 24 opposite the end portion 16. The free end 24 of the pedal arm 12 may include a pad (not shown) providing surface support for the foot of a user. The end portion 16 of the pedal arm 12 is dispose in the first housing portion 36.

The rotatable member 18 is housed between the pair of spaced apart side walls 30. Specifically, the rotatable member 18 is disposed in the second housing portion 38. The rotatable member 18 is mechanically linked to the end portion 16 of the pedal arm 12 so as to rotate upon depression of the pedal arm 12.

The pedal assembly 10 includes a first pivot point 40 and a second pivot point 42. The end portion 16 of the pedal is rotatably mounted to the first pivot point 40, so as to rotate about the first pivot point 40. The rotatable member 18 is rotatably mounted to the second pivot point 42, so as to rotate about the second pivot point 42. Preferably, the first and second pivot points 40, 42 are a first pivot rod 44 and a second pivot rod 46 respectively. The first pivot rod 44 extends between opposing portions of the side walls 30 of the first housing portion 36. The second pivot rod 46 is fixedly mounted to a side wall 30 of the second housing portion 38.

The rotatable member 18 is pivotably mounted to the second pivot rod 46 so as to rotate about the second pivot rod 46. The rotatable member 18 is operatively connected to the end portion 16 of the pedal arm 12 so as to rotate upon depression of the free end 24 of the pedal arm 12. The position sensor 20 may be mounted to the side wall 30 of the second housing portion 38 and is operable to detect the degree of rotation of the rotatable member 18. The first and the second pivot rods 44, 46 are connected by a pair of gear wheels 48, 50 or gear segments 52, 54 permitting a compact configuration for the pedal assembly 10.

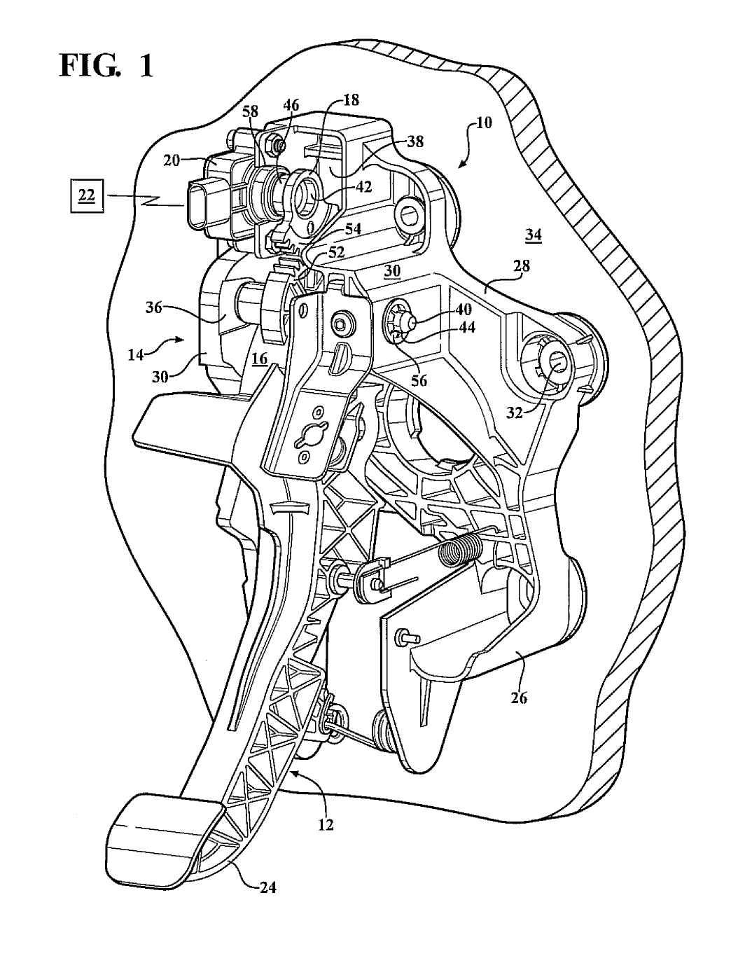

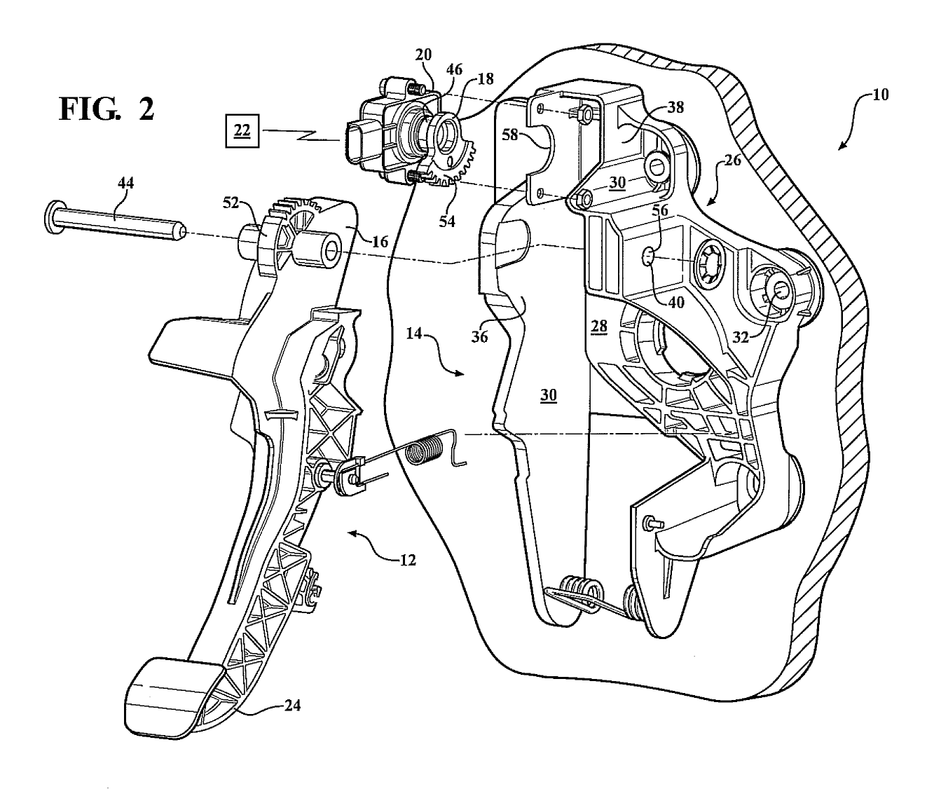

With reference first to FIGS. 1-4, a first preferred embodiment of the pedal assembly 10 is provided. The pedal assembly 10 includes first and second gear segments 52, 54. The end portion 16 of the pedal arm 12 includes a first gear segment 52. The first gear segment 52 is housed in the first housing portion 36. The first gear segment 52 is rigidly formed to the end portion 16. The end portion 16 is rotatably mounted to the first pivot rod 44 so as to be rotatably supported by the sides of the bracket 26. The end portion 16 includes a first aperture 56. The first pivot rod 44 is fixedly supported by the sides of the bracket 26. The first aperture 56 is configured to pivotably engage the first pivot rod 44. The first pivot rod 44 extends through the first aperture 56 so as to allow for the pedal arm 12 to pivot or rotate about the first pivot point 40 as indicated by the arrow.

The rotatable member 18 includes a second gear segment 54 configured to enmesh with the first gear segment 52. The second gear segment 54 forms an outer surface portion of the rotatable member 18. The rotatable member 18 includes a second aperture 58. The second pivot rod 46 is configured to slidingly engage the second aperture 58. The second pivot rod 46 is spaced apart and parallel to the first pivot rod 44. The rotatable member 18 is rotatable about the second pivot point 42. The second gear segment 54 is housed in the second housing portion 38. The second gear segment 54 is enmeshed with the first gear segment 52.

The position sensor 20 is fixedly mounted to one of the pair of side walls 30, and the second gear segment 54 is rotatably mounted to the position sensor 20. A suitable position sensor 20 is manufactured by KSR, the assignee of this application. However, any type of position sensor 20 having a rotor such as a Hall effect position sensor 20 may be used, A processor 22 is in electrical communication with the position sensor 20. The processor 22 is operable to calculate the degree of pedal depression based upon the rotation of the rotatable member 18.

The first and second gear segments 52, 54 are configured to engage each other wherein rotation of the first gear segment 52 about the first pivot point 40 rotates the second gear segment 54 about the second pivot point 42. For instance, the first gear segment 52 and second gear segments 54 may be a segmented portion of a helical gear, or a spur gear.

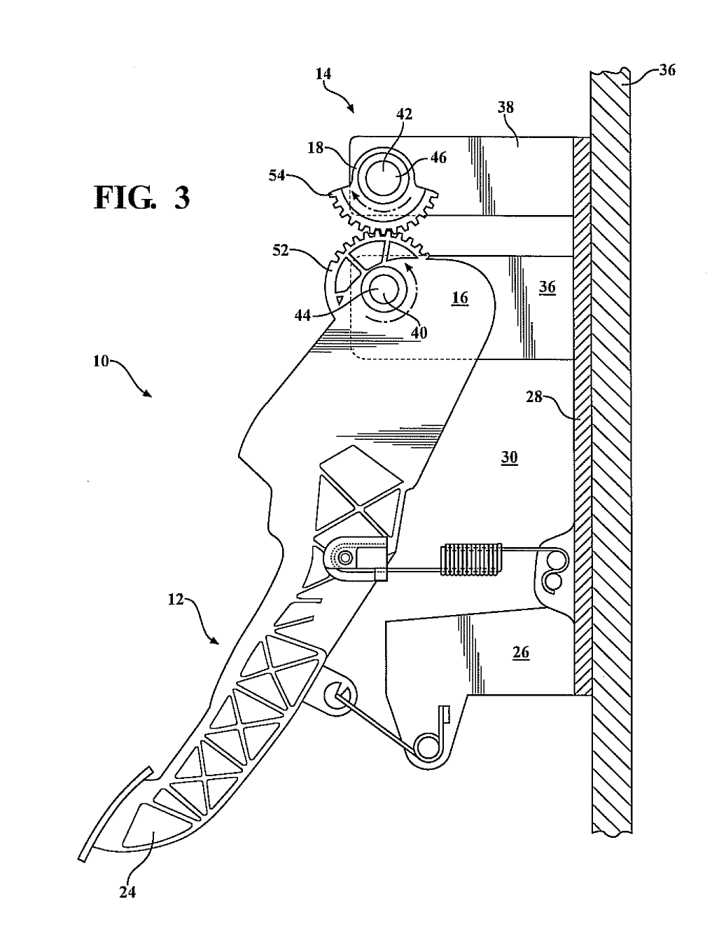

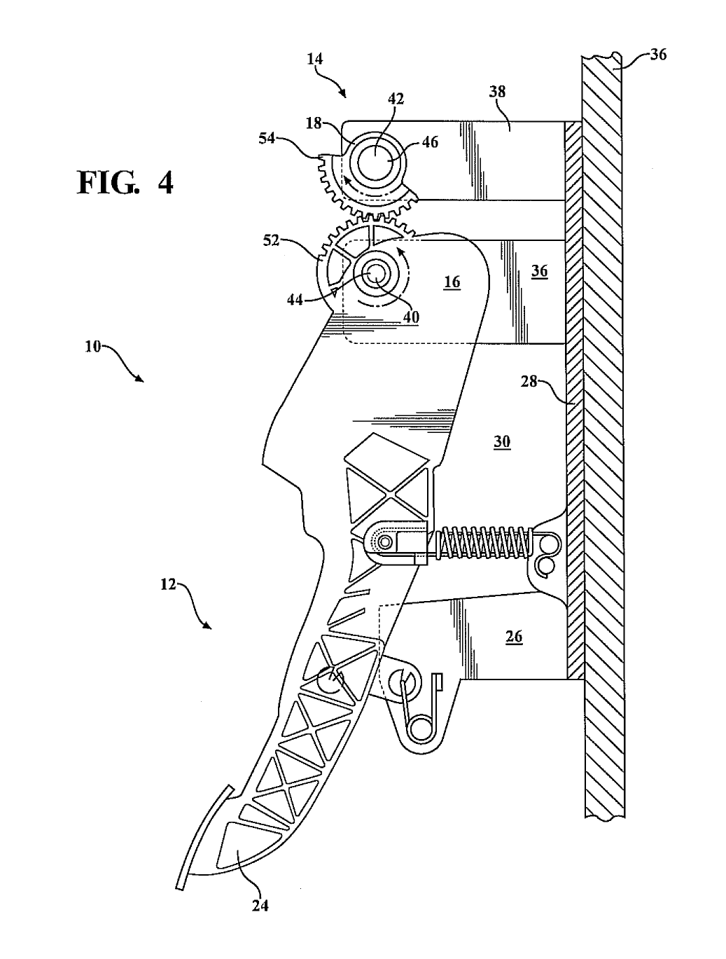

With reference now to FIGS. 3 and 4, an operation of the pedal assembly 10 is provided. With reference first to FIG. 3, the pedal assembly 10 is shown in a natural state, meaning the pedal arm 12 is not depressed. The first gear segment 52 is mechanically engaged with the second gear segment 54. The first gear segment 52 is fixedly formed to the end portion 16 of the pedal arm 12. The second gear segment 54 is fixedly formed to the rotatable member 18. The first gear segment 52 is enmeshed with the second gear segment 54. The end portion 16 of the pedal arm 12 and the rotatable member 18 are pivotable about respective first and second pivot points 40, 42, via respective first and second pivot rods 44, 46.

With reference now to FIG. 4, the pedal arm 12 is shown depressed. As the pedal arm 12 is depressed the first and second gear segments 52, 54 are rotated. Specifically, the first gear segment 52 is rotated counter-clockwise a predetermined degree and the second gear segment 54 is rotated clockwise the same predetermined degree. It should be appreciated that the degree of rotation of respective first and second gear segments 52, 54 may differ in instances where the first and second gear segments 52, 54 have different length radiuses.

The position sensor 20 is operable to detect the degree of rotation of the second gear segment 54. The sensor transmits the degree of rotation to the processor 22. The processor 22 processes the degree of rotation to calculate a degree of depression of the pedal assembly 10 so as to actuate the throttle or brakes accordingly. The processor 22 may further take into consideration the rate at which the second gear segment 54 rotated so as to effect the actuation of the throttle or brake. For instance, in cases where the pedal assembly 10 is operable to actuate the brake, a relatively quick rotation of the rotatable member 18 may produce cause a corresponding tightening of the brakes so as to stop the vehicle sharply.

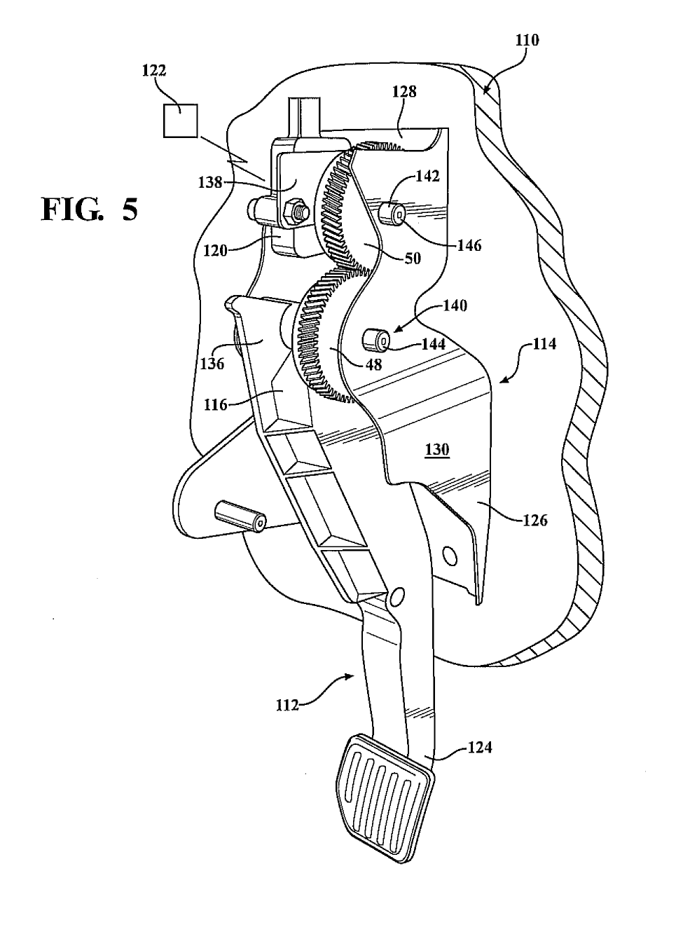

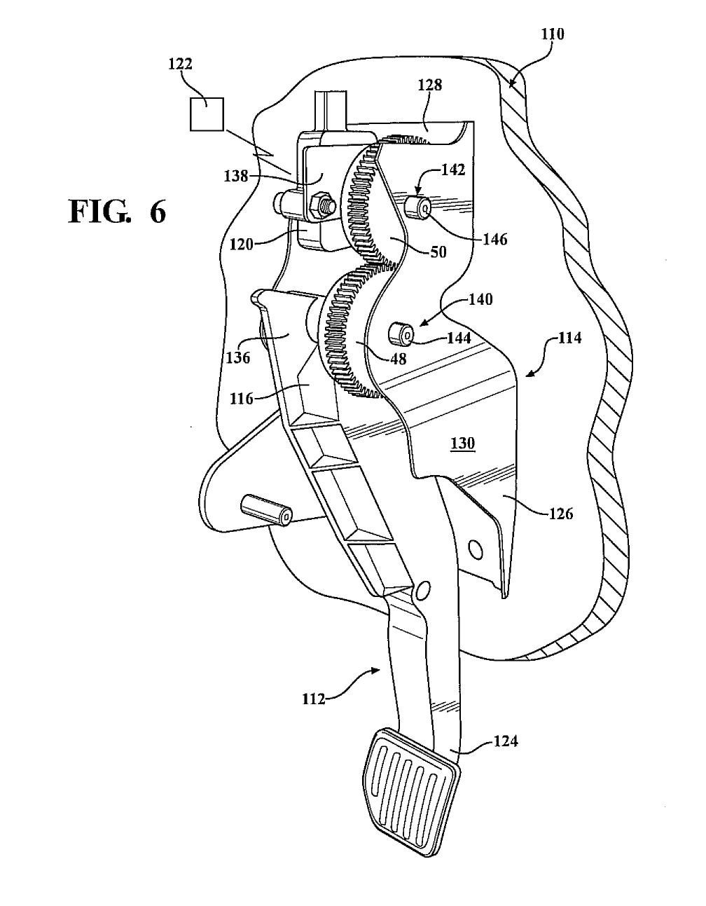

With reference now to FIGS. 5 and 6, a second preferred embodiment of the pedal assembly 110 is provided, wherein like parts are indicated by numerals offset by 100. The pedal assembly 110 includes a first and second gear wheel 48, 50. The first and second gear wheel 48, 50 are disposed within respective first and second housing portions 136, 138.

The end portion 116 is fixedly attached to a first gear wheel 48. The first gear wheel 48 is rotatably mounted to the first pivot rod 144. The second gear wheel 50 is pivotably attached to the second pivot rod 146. The first gear wheel 148 may be a helical gear or a spur gear. The second gear wheel 50 is a corresponding helical or spur gear adapted to enmesh with the first gear. The first and second gear wheels 48, 50 are configured to engage each other wherein rotation of the first gear wheel 48 about the first pivot point 140 rotates the second gear wheel 50 about the second pivot point 142.

The position sensor 120 is fixedly mounted to one of the pair of side walls 130, and the position sensor 120 is operable to detect the rotation of the second gear wheel 50. The processor 122 is in electrical communication with the position sensor 120, and operable to calculate the degree of pedal depression based upon the degree of rotation of the second gear wheel 50.

Obviously, many modifications and variations of the present invention are possible in light of the above teachings and may be practiced otherwise than as specifically described while within the scope of the appended claims. For instance, the first gear segment 52 formed on the end of the pedal arm 12 could be pinned to the pedal. Any type gear or gear segment which can produce linear travel can be used including spur and helical gears. Likewise, the parallel shift arrangement can be used with other types of pedal assemblies 10 such as organ stop pedals.

Thus disclosed is a pedal assembly 10 having a bracket 26 and a rotary position sensor 20 which is mounted between the arms of the bracket 26. It is clear that many variations are within the scope of the invention,

1. An electronic pedal assembly for use in a vehicle, the electronic pedal assembly comprising:
a pedal arm having an end portion, the end portion rotatable about a first pivot point;
a rotatable member rotatable about a second pivot point, the rotatable member mechanically linked to the end portion of the pedal arm so as to rotate about the second pivot paint upon depression of the pedal arm; and
a position sensor connected to the rotatable member, the position sensor operable to detect the degree of rotation of the rotatable member upon depression of the pedal arm, the position sensor transmitting the degree of rotation to the vehicle.

2. The electronic pedal assembly as set forth in claim 1, wherein the end portion of the pedal arm includes a first gear segment, and the rotatable member includes a second gear segment configured to enmesh with the first gear segment.

3. The electronic pedal assembly as set forth in claim 2, further including a housing, the housing having an elongated center portion, and a pair of side walls extending outwardly from the sides of the elongated center portion, the housing having a first housing portion and a second housing portion, the first housing portion axially aligned with the second housing portion, the first gear segment rotatably disposed in the first housing portion, the rotatable member disposed in the second housing portion.

4. The electronic pedal assembly as set forth in claim 1, wherein the rotatable member is a second gear segment enmeshed with the first gear segment.

5. The electronic pedal assembly as set forth in claim 3, wherein the position sensor is fixedly mounted to one of the pair of side walls, and the second gear segment is rotatably mounted to the position sensor.

6. The electronic pedal assembly as set forth in claim 3, further including a processor in electrical communication with the position sensor, the processor operable to calculate the degree of pedal depression based upon the rotation of the rotatable member.

7. The electronic pedal assembly as set forth in claim 1, wherein the end portion is a segmented portion of a first helical gear and the rotatable member is segmented portion of a second helical gear.

8. The electronic pedal assembly as set forth in claim 1, wherein the end portion is a segmented portion of a first spur gear and the rotatable member is a segmented portion of a second spur gear.

9. The electronic pedal assembly as set forth in claim 1, wherein the end portion is fixedly attached to a first gear wheel and the rotatable member is a second gear wheel.

10. The electronic pedal assembly as set forth in claim 9, wherein the first gear wheel is a first spur gear and the second gear wheel is a second spur gear.

11. The electronic pedal assembly as set forth in claim 9, wherein the first gear wheel is a first helical gear and the second gear wheel is a second helical gear.
